(19) United States
(12) Patent Application Publication
(10) Pub. No.: US 2007/0257785 A1
(43) Pub. Date: Nov. 8, 2007

(54) HIGH AND LOW TIRE PRESSURE INDICATOR

(76) Inventor: ANDZREJ ZBIGNIEW OBOZA, MOORPARK, CA (US)

Correspondence Address: ANDRZEJ OBOZA, 11743 PINEDALE RD, MOORPARK, CA, 93021, US

(21) Appl. No.: 11/306,783

(22) Filed: Jan. 11, 2006

(51) Int. Cl. B60C 23/02

(52) U.S. Cl. 340/442; 73/146.8

(57) ABSTRACT

This system will monitor the pressure of individual tires on a vehicle and inform the operator in the event where there is an out of range pressure(s) detected. This system consists of valve core, control cap, and monitoring display unit (M.D.U). The valve core will measure internal tire pressure that will trigger a high or a low-pressure switch on the controlling cap. The Controlling cap then will send this signal to the M.D.U that will inform the operator with high or low-pressure tire(s) and the location(s).

This tire pressure monitoring system has been designed so that it can be used on a wide range of vehicles for people that would like to drive safer by monitoring tire pressure. Maintaining a proper tire pressure is very important in safety, excessive tire wear, excessive fuel consumption, etc.

Our high and low tire pressure indicator is very unique and precise that it can be used in any type of vehicle.

It is monitoring the tire pressure:
A. Normal recommended manufacturer tire pressure
B. Low tire pressure
C. High tire pressure

Our system considers and is variable to the conditions of temperature having a big impact on tire pressure. There are many sources in generating the temperature, such as:

1. Atmospheric condition (temperature)

2. Tire pressure

3. Tire condition

4. Often breaking
a. Over-heating tires
b. Break drums (break components) emitting/radiating heat the tires and wheel

5. Weight of the vehicle

6. Driving speed

7. Road condition

The system has the ability to inform the driver about the tire pressure failing during operation or non-operation of the vehicle.

The indication system is made from a special valve core, controlling cap, and monitoring panel. The valve core is mounted in the tire steam valve, the same way like the ordinary valve core. The moving pin connected to the flexible diaphragm in the plunger sleeve that is made from a temperature active material makes this system sensitive for tire pressure.

This system will inform the driver about the tire pressure fluctuation, the range of 2 PSI below and 5 PSI above the normal recommended tire pressure. The range of 7 PSI applies to big rig and the smaller range will apply to smaller vehicles. The temperature active sleeve and the adjustable cap will prevent from triggering the alarm when existing low or high tire pressure in the tire that is a result of outside temperature and fluctuation, which is a normal occurrence.

Monitoring Display Unit (M.D.U)

This system has been designed to visually and audibly alert the vehicle operator, in the event of unsafe tire pressure, which could result in an unsafe driving condition. The operator will have a display panel that can be mounted anywhere in the cab with clear

The system uses a predetermined internal pressure that is allowed to fluctuate within a safe pressure range. If the pressure drops below 2 psi an internal trigger will send a RF signal from the control cap to the dashboard control notifying the operator of a low-pressure alert green LED and buzzer. The same would go if tire pressure would rise above 5 psi, this would trigger the high-pressure alert red LED and buzzer.

This pressure range will also be automatically shifted for the control cap by the valve core (temperature active sleeve and temperature active adjusting cap in the control cap) to adapt to varying tire temperature changes. This will help the vehicle maintain proper and safe tire pressure for the current conditions.

Valve Core

The valve core is a key piece in the functionality of the entire system. Our valve core is designed so that it is installed in place of the existing valve core in the wheel's valve stem, which making it possible to install our system onto any vehicle. What makes our valve core so unique is that, not only does it work like a basic valve core that allows inflation of a tire, but it also allows the valve's pin to move inward as pressure drops and outward as tire pressure rises. This inward and outward movement of the pin will trigger contacts (2-way electric switch) on the control cap, which then translates this signal and sends it via RF into the M.D.U. to make an indication about the location and the fault in pressure of that tire.

Construction of the Valve Core FIG. 2.-FIG. 2a.

This new valve core is designed to take the place of existing valve cores

The valve core FIG. 2. has 2 main body segments the plug FIG. 2. 2-1 and plunger FIG. 2. 2-2 with a pin shaft FIG. 2. 2-3 that runs through the middle of the valve core from top visibility of the panel. The display panel will have a picture that reflects the vehicle's shape with light-emitting diodes (LEDs) placed in the vehicles tire locations. The LEDs will flash to indicate the location of a problem tire or tires. The LED will flash either red for high-pressure or green for low-pressure status for that tire. Simultaneously with the flashing LED, the operator will hear a buzz coming from the display panel indicating that an LED has illuminated. The operator now may press the check button on the display panel to acknowledge that they have been alerted of the unsafe tire pressure. Pressing the check button will cancel the buzzer only, the LED will continue flashing until proper repairs have been made to the tire(s) and the clear button has been pressed on the display panel. The display panel has been made portable to easily help located the problem tire once outside the vehicle. The display panel will switch to an internal battery source when separated from its power supplying mounting cradle.

Control Caps

The LEDs on the control panel will be triggered through Radio Frequency (RF) that is sent from a control cap mounted on the stem valve of each wheel. The control caps each contain a coded RF Transmitter, which will indicate to the control panel of which wheel has been triggered. The control caps have been designed with LEDs on the tops to easily alert the vehicle operator on a visual pre-trip inspection of each wheel. These LEDs will flash either red for high-pressure or green for low-pressure to help locate a possible tire pressure problem before driving off with the vehicle. The control caps will be powered by a small internal battery, which should last a lifetime since the control cap only draws power when there is a fault in tire pressure detected.

to diaphragm top cap FIG. 2. 2-8. The pin shaft comprises from top to the bottom: of a pinhead at the top, a pin push-stop FIG. 2. 2-4 at the middle and connected to the diaphragm top cap FIG. 2. 2-8 on the bottom.

The top of the body is the plug FIG. 2. 2-1 and at the bottom is the plunger FIG. 2. 2-2. The plug FIG. 2. 2-2 has threads on the outer body with outer rubber seal FIG. 2. 2-6 this is where it threads itself to the valve stem FIG. 1. 1-1. At the bottom of the plug FIG. 2. 2-1 is the plug seat FIG. 2. 2-5 with integrated rubber seal separates the plug seat and plunger head FIG. 2. 2-2. The plunger is made to be a hollow cylindrical piece, which includes a plunger head at the top, sleeves as the sidewalls, and the base at the bottom. The plunger sleeve FIG. 2. 2-2 are made of a temperature sensitive material that will extend and condense. On the inside of the plunger FIG. 2. 2-2 are the inner spring FIG. 2. 2-7 and the diaphragm FIG. 2. 2-9. The bottom of the diaphragm has an airtight seal around the plunger base FIG. 2. 2-10. The plunger has the outer spring FIG. 2. 2-11 attached on bottom of the plunger base (with center hole) FIG. 2. 2-10.

Functionality of the Valve Core FIG. 1. 1-1-FIG. 4a.4b.4c.4d.

Inflating a tire, the air pump makes contact with the valve stem FIG. 1. 1′-1 outer thread, simultaneously pressing down the pin FIG. 2. 2-3 on the core valve FIG. 2. as the pin FIG. 2. 2-3 is moving downward the push stop FIG. 2. 2-4 on the pin makes contact with the top of the plunger FIG. 2. 2-2 pressing down, simultaneously uncompressing the inner spring FIG. 2. 2-7 and suppressing the diaphragm FIG. 2. 2-9 The plunger FIG. 2. 2-2 moves downward compressing the outer spring FIG. 2. 2-11 and separating the plunger head FIG. 2. 2-2 from the plug seat of valve core plug FIG. 2. 2-1. Simultaneously compressed air will flow into the tire through the plug through the opened gap between plug seat of the plug FIG. 2. 2-1 and plunger head of the plunger FIG. 2. 2-2

After completing the inflation procedure, and disconnecting the air pump, the outer spring FIG. 2. 2-11 will expand pushing the plunger FIG. 2. 2-2 towards closing the opened gap at the plug seat of the plug FIG. 2. 2-1. The compressed air from the tire will seep into the diaphragm FIG. 2. 2-9 through the hole in the plunger base FIG. 2. 2-10. The air pressure will expand the diaphragm FIG. 2. 2-9 upwards with the pin FIG. 2. 2-2 compressing the inner spring FIG. 2. 2-7. The movement will stop once the force of inner spring FIG. 2. 2-7 and the force of diaphragm FIG. 2. 2-9 from the air pressure air pressure has been equalized. The predetermined value compression position of the inner spring FIG. 2. 2-7 determines the distance that the pin FIG. 2. 2-3 will protrude from the plug FIG. 2. 2-1 The greater the air pressure in the diaphragm FIG. 2. 2-9 the greater distance the pin FIG. 2. 2-3 will protrude from the plug FIG. 2. 2-1 The inner spring FIG. 2. 2-7 can be set to any predetermined pressure for various applications.

System Operation in Low Pressure

This system is equipped with two kinds of warning systems that inform the driver about the tire pressure status during operation and non-operation of the vehicle. If any of the tires' air pressure drop (see FIG. 4B.) the inner spring FIG. 2. 2-7 in the core valve FIG. 2. will expand because the air pressure dropping in the flexible diaphragm FIG. 2. 2-9 (get softer). This will move the pin FIG. 2. 2-3 downward by pushing down the diaphragm mount FIG. 2. 2-8 together with the pin FIG. 2. 2-3. The pin FIG. 2. 2-3 will move downward until the spring FIG. 2. 2-7 force gets equal with the resistant of the flexible diaphragm FIG. 2. 2-9. The pin (head) FIG. 2. 2-3 support the trigger arm FIG. 3. 3-4 of the two-way electrical switch FIG. 3. 3-(4,11,12). The pin FIG. 2. 2-3 moving downwards to the low pressure terminal FIG. 3. 3-12 closing the circuit. The battery FIG. 3. 3-7 will activate the low pressure warning system of the RF transmitter FIG. 3. 3-6 in the controlling cap FIG. 3. The RF transmitter FIG. 3. 3-6 will send a signal to the receiver FIG. 5. M.D.U. and the LED (LEDs) FIG. 5 will emit green light flashing. The green flashing LED indicates location of the low-pressure tires on the M.D.U. FIG. 5. At the same time, an acoustic buzzer (audio signal) FIG. 5. 5-2 will be activated. By pressing the clear button FIG. 5. 5-2 the audio signal turn of. The LEDs on the M.D.U FIG. 5 and LED in the FIG. 3. will remain flashing until the tires are repaired. The M.D.U FIG. 5. to display at once many problems tires as occur.

System Operation in High Pressure

If one of the vehicles tires air pressure exceeds over the recommended maximum pressure value, the pressure will expand upwards, the flexible diaphragm FIG. 2. 2-9 this will cause the compression of the inner spring FIG. 2. 2-7 and moving up the pin FIG. 2. 2-3 The pinhead of the pin FIG. 2. 2-3 pushing up the trigger arm FIG. 3. 3-4 of the two way electrical switch FIG. 3. 3 (4,11,12) creating contact with the high-pressure terminal FIG. 3. 3-11 closing the circuit. The pin movement will stop bay the push stop bracket FIG. 2. 2-4 mounted on the pin FIG. 2. 2-3 preventing any damage to the 2-way switch. The battery FIG. 3. 3-7 will activate the high-pressure warning system where the RF transmitter FIG. 3. 3-6 which will send the signal to the receiver of the monitoring display unit FIG. 5. (FIG. 5A) (M.D.U). The LED FIG. 3. 3-8 build in the controlling cap cover FIG. 3. 3-1 will start flashing. The M.D.U mounted in the driver cabin will be displayed by flashing LED FIG. 5 (1-18) will showing locations of problem tires on the display. The flashing LED indicates high pressure in the tires as a problem. At the same time, activating the acoustic buzzer FIG. 5. 5-1 will send the audio signal. By pressing the clear button FIGS. 5-2 the audio signal will be cleared but the LED (LEDs) will remain flashing. After the tires is repaired and control cap is mounted back on the stem valve, and flashing LED will automatically turn off.

### BRIEF DESCRIPTION OF THE DRAWINGS

All drawings are made on an enlarged scale

FIG. 1. Showing cross section of an assembly monitoring cap and valve core mounted on the valve stem.

FIG. 1A. Showing 3D sectional drawing of assembly described on FIG. 1

FIG. 2. Showing cross section of an assembly of the valve core

FIG. 2A. Showing 3D exploded view of the valve core assembly.

FIG. 2B showing 3D through viewable valve core assembly.

FIG. 3. Showing cross section of the monitoring cap assembly

FIG. 3A. Showing 3D sectional view of the monitoring cap assembly

FIG. 3B. Showing diagram of electric circuit of radio wave transmitter mounted in monitoring cap.

FIG. 4A. shows normal position of FIG. 1. assembly.

FIG. 4B. shows low position of FIG. 1. assembly.

FIG. 4C. shows high position of FIG. 1. assembly.

FIG. 4D. showing cross section of valve core of open position by inflating tires

FIG. 5. Showing front panel of monitoring display unit

FIG. 5A. showing diagram of the electric circuit of the monitoring display unit

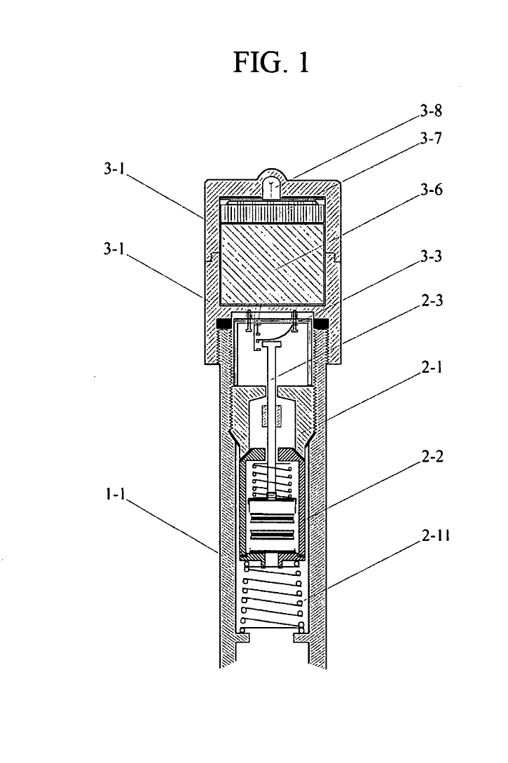

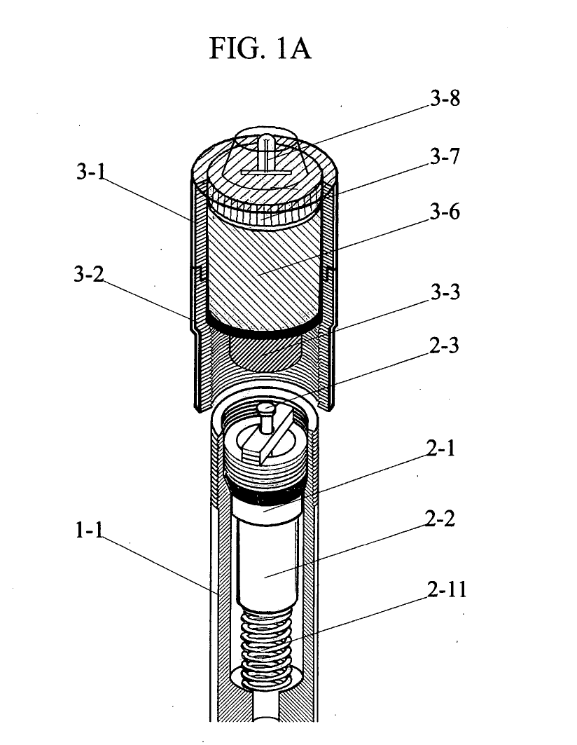

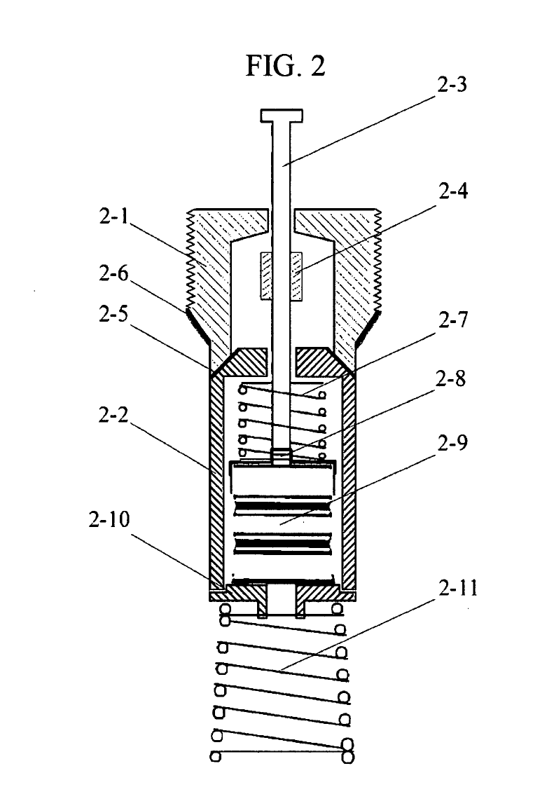

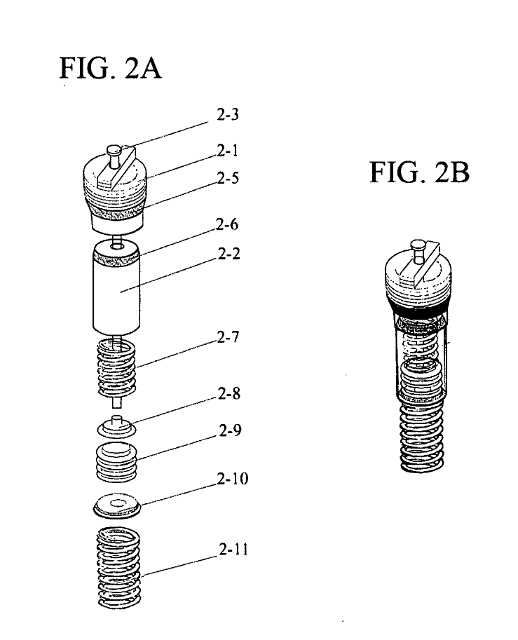

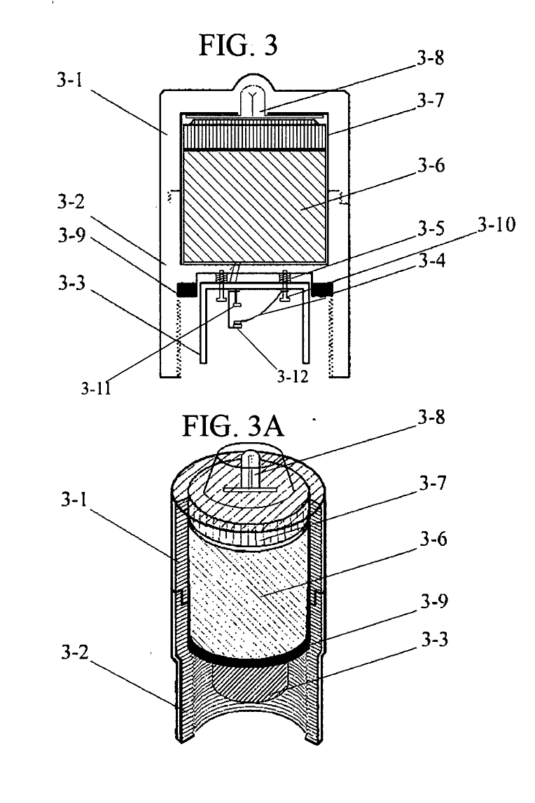

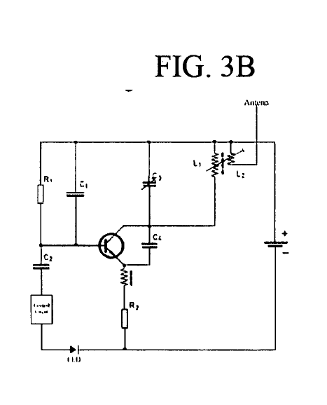

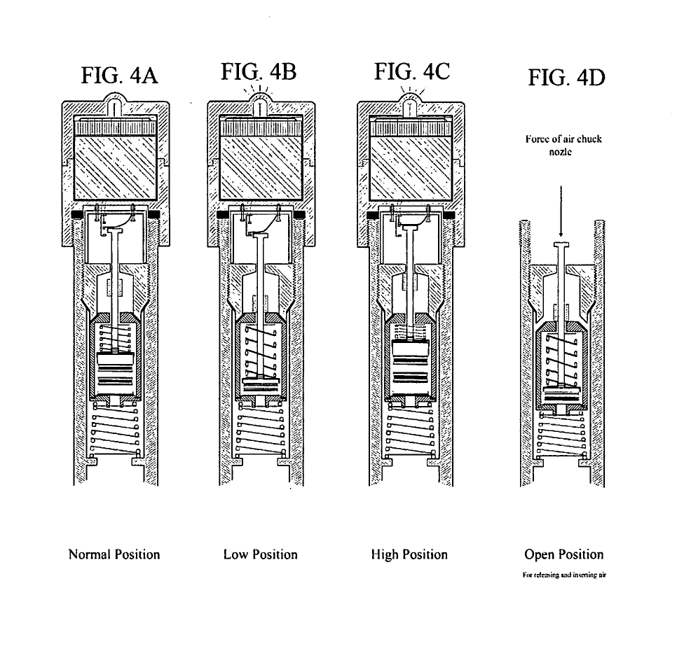

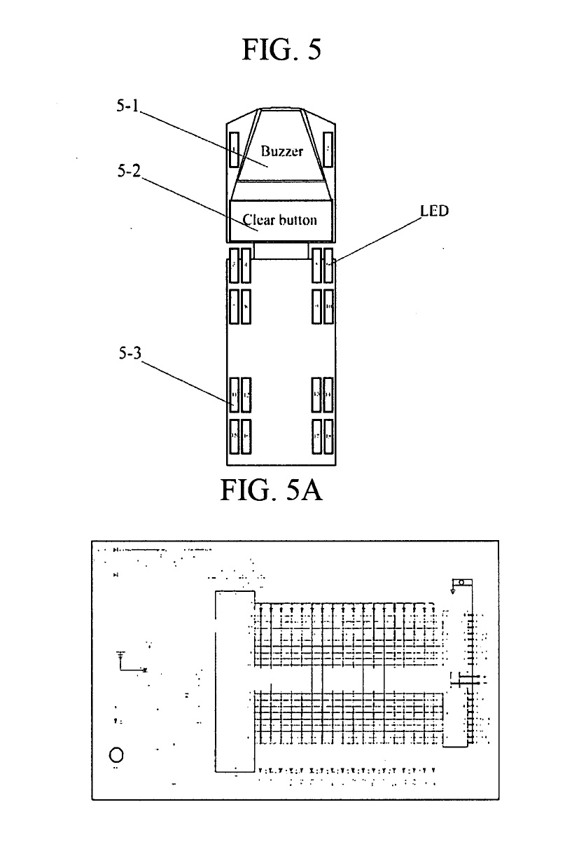

### INSTALLATION

Valve Core

Installation is done with a simple valve core remover tool. By using this tool you will remove the basic valve core from within a wheel's valve stem, and replace it with the new pressure sensing valve core. Follow this procedure will the rest of the vehicle wheels.

Control Caps

Now it is time to install the control caps in their specified locations. The locations of the control caps are an important factor that will help the control panel correctly identify the location of a wheel with a fault in its pressure. Each control cap will have a unique number marked on its side that will help in mounting in the proper location of your vehicle. (Ex. cap 1 will be on the front right. Cap 2 will be on the front left . . . and so on)

Monitoring Display Unit

Next you will need to mount the display panel anywhere you would like so that you will have a clear view of the panel. The control panel's mounting cradle will need power from a source (cigarette lighter or any switched ignition source) and a chassis ground from: the vehicle. Installation of the system is complete and ready to use. When the display panel is seated in the cradle power will be supplied to the display panel through the cradle. When you detach the display panel from the cradle the display panel will be powered from the internal bat.

What is claimed is:

1. The diaphragm valve core is installed in the tire valve stem like the ordinary valve core.

2. The valve core constantly remains in a closed position, which means that by installing the monitoring cap there will be no air released from the tire to the cap.

3. The moveable diaphragm that is inside the temperature active sleeve in which both are a part of the valve core plunger.

4. The plunger at the top has a valve head, at the bottom cylindrical shaped sleeve and is made from temperature active material.

5. The sleeve will prevent from triggering the alarm of high or low pressure in the tire as a result of influence of outside temperature (Tire pressure) and fluctuation.

6. The moveable diaphragm is mounted inside the plunger with the opening to the sleeve bottom.

7. The moveable pin is mounted to the top of the moveable diaphragm.

8. The moveable pin has stop push bracket mounted above the plunger head.

9. Within the plunger is the inner spring that is mounted to the base of the plunger head and to the top of the moveable diaphragm to compress the diaphragm.

10. Outer spring is mounted on the underside of the plunger enclosure and to the valve stem inner groove, to keep plug and plunger constantly in a closed position.

11. The monitoring cap has been installed at the top of the tire valve stem.

12. The monitoring cap is activated by a moveable pin in the valve core if the tire pressure raises or drops it will make contact with the two way switch.

13. The monitoring cap is made from two body segments connected together with the self-sealing thread.

14. The monitoring cap is waterproof and does not require any breather.

15. Inside the top body segment of the monitoring cap is a built in:
a) Battery cell.

16. LED.

17. The battery will be used to activate the radio wave sender and LED only when the tire pressure drops below or raises above the recommended pressure range. By maintaining proper tire pressure the battery will last a lifetime.

18. Inside the bottom body segment of the monitoring cap, at the top is the radio wave compartment and below that is the compartment where a moveable self-adjusting cap that is made from a temperature active material.

19. Inside the adjusting cap is built-in two-way (high and low) electric switch.

20. The two way will trigger the RF by a moveable pin creating contact through the trigger arm with the high and low terminal.

21. The system has two alarms:
a) Audio (buzzer)
b) Visual (flashing LED mounted on each tire and inside cabin in the monitoring display)
1) The monitoring display unit reflects the shape of the vehicle and the LED reflects the location of each tire.

22. The M.D.U. has ability display simultaneously as many problem tire(s) that occur at any time.

23. The monitoring display unit is equipped with a buzzer and a reset button. The reset button only clears the audio signal and the trouble tire will remain on until the tire is repaired.

24. The monitoring display unit is equipped with it's own power source battery which makes it portable and can be installed in any location of the cabin. It will also be capable of be hooked up with a power cap to the vehicle power source (ex. cigarette light).

25. Each cap will contain quoted radio waves transmitter allowed installation to the monitoring cap to the right wheels according which the display tire location. To align by installation tire location of the vehicle with the location of the monitoring display unit.
